(19) United States
(12) Patent Application Publication
(10) Pub. No.: US 2002/0169671 A1
(43) Pub. Date: Nov. 14, 2002

(54) Electronic product registration system with sales incentive program management function

(76) Inventor: Peter J. Junger, Redmond, WA (US)

Correspondence Address: NIXON & VANDERHYE P.C., 8th Floor, 1100 North Glebe Road, Arlington, VA, 22201, US

(21) Appl. No.: 10/131,493

(22) Filed: Apr. 25, 2002

Related U.S. Application Data
(63) Continuation-in-part of application No. 09/509,021, filed on Jul. 25, 2000.
(60) Provisional application No. 60/286,972, filed on Apr. 30, 2001.

(51) Int. Cl. G06F 17/60

(52) U.S. Cl. 705/14

(57) ABSTRACT

An electronic product registration (ER) system that manages sales incentive programs to assure that proper credit (e.g., spiff) is given under such programs in accordance with the particular incentive policies associated therewith. The ER system enables sales incentive programs or the like to be more easily implemented, managed and carried out in accordance with the applicable rules and procedures. The invention reduces and/or prevents improper commissions or spiffs from being paid as well as assures that proper commissions are paid when appropriate. By monitoring sales and returns of serialized products for which an incentive program has been defined, the ER system provides accurate reports on credits earned under such programs.

### RELATED APPLICATIONS

This application is a continuation-in-part of U.S. patent application Ser. No. 09/509,021 entitled “Electronic Product Registration System with Sales Incentive Program Management Function” and filed Jul. 25, 2000.

This application also claims the benefit of U.S. Provisional Application Serial No. 60/286,972 entitled “ERS System With Manufacturer Rebate Validation and Management Function” and filed on Apr. 30, 2001.

### FIELD OF THE INVENTION

The instant invention relates to the field of electronic registration of purchased products, and more particularly, to an improved electronic registration (ER) system which can be advantageously used to manage sales incentive programs to assure that proper credit (e.g., Spiff) is given under such programs in accordance with the particular incentive policies associated therewith. In other words, the invention enables sales incentive programs or the like to be more easily implemented, managed and carried out in accordance with appropriate rules and procedures. The invention reduces and/or prevents improper commissions or spiffs from being paid as well as assures that proper commissions are paid when appropriate under the applicable rules and procedures defined for the particular incentive program under which the commission(s) have been earned. The invention greatly simplifies the implementation and management of sales incentive programs when used in connection with serialized or other uniquely identified products.

### BACKGROUND AND SUMMARY OF THE INVENTION

Electronic registration (ER) of product transactions has become available for the purpose of reducing unauthorized returns of purchased products and/or unauthorized warranty repair on purchased products. Electronic product registrations systems provided for this purpose are disclosed in, for example, U.S. Pat. Nos. 5,978,774, 6,018,719 and 6,085,172, the disclosures of which are all incorporated by reference herein in their entirety. The electronic registration system relies on the use of a unique identifier, such as a serial number, for each product that is purchased. The serial number is obtained at the point of sale for inclusion in a registration database, together with other information, such as a date of transaction. This database can then be accessed in connection with an attempted product return/warranty transaction for the purpose of determining if the product qualifies for return/warranty under applicable return/warranty criteria (which is also stored in the ER system). Such electronic systems may also be used in connection with repair and/or exchange transactions, in addition to returns, by enabling an accurate determination as to whether the product qualifies for any of these actions under the appropriate policies and criteria under which the product was originally sold.

The ER system uses pre-established return/repair policies and procedures that are programmed into the system so that the system can perform a check when a product is presented for return to determine if the product qualifies for return, replacement and/or warranty repair based on sales transaction information available in the ER system for the particular product at issue. Thus, known ER systems include a database of return qualification information (or warranty/replacement criteria) for various manufacturer's which enables the system to make an accurate determination with respect to whether or not a product actually qualifies for return (or warranty/replacement) based on the appropriate criteria and at the time the product is presented for return. Such ER systems have greatly reduced improper and fraudulent returns and warranty claims.

While such ER systems have proven to be very useful in their current forms, additional improvements in the system are still desired to give such ER systems more functionality in operation in order to benefit customers, retailers and/or manufacturers. To this end, the instant invention provides an improved ER system that has increased functionality, by providing an enhancement to known ER systems that can be used to implement and manage sales incentive programs. In such programs, for example, a sales person, a store or the like is offered a commission for selling certain products during certain times by the product's manufacturer or other party. Such commissions are typically referred to as a “spiff” in the retail industry. These incentive programs are designed to increase sales and/or profits for the manufacturer by giving the sales personnel and/or the store an incentive to sell the manufacturer's or vendor's products as opposed to other products. For example, a camera manufacturer may offer a sales incentive program to a retail camera store that sells cameras of many different manufacturers, wherein the manufacturer offers to pay a percentage or flat fee to the store or sales person for sales of its cameras over and above the typical compensation that the store or sales personnel receives from making such sales. The program may be limited in time, e.g., only for sales that occur during the month of October or on a holiday, and/or may have other limitations and/or requirements established by the manufacturer. The manufacturer and/or retailer will typically maintain records of sales covered by the incentive program, so that periodic payments (spiffs) can be made to the appropriate person or entity responsible for the sales.

While such sales incentive programs have proven to be a valuable sales and marketing tool in connection some products, there are numerous problems that can occur during implementation of such programs that can adversely affect the success of the program. For example, accurate accounting and reports must be maintained in order to enable the commissions or spiffs to be paid out accurately. Moreover, the program must be monitored so that product returns are properly taken into account. In other words, if a sales person sells a product qualifying under an incentive program, the sales person would be entitled to the spiff unless the product is later returned by the purchaser. Thus, information must be maintained to enable proper accounting in connection with spiff payments that takes into account the many possibilities that can occur in relation to a sales transaction, such as product returns. Otherwise, the manufacturer may improperly pay spiffs when no sale has actually occurred due to a product return. In addition, there are typically numerous different sales personnel that may participate in the incentive program. Thus, information must be kept that keeps track of who made what sales, so that the proper person is identified for spiff payments. This obviously further complicates the program in connection with accounting for returns. Specifically, it becomes difficult to know who to debit the return to among all of the personnel participating in the incentive program. Also, such incentive programs may have various specific criteria that must be met in order to qualify for the incentive payment.

Thus, incentive programs can be very burdensome to implement and manage properly, thereby detracting from the success of such programs. Such incentive programs are also susceptible to fraud by unscrupulous individuals who attempt to improperly profit from incentive programs by, for example, improperly reporting sales and/or not reporting return transactions in order to obtain spiff payments that are not properly owed. Thus, incentive programs have the potential for unscrupulous persons to fraudulently take advantage of such programs for the purpose of misappropriating money from the manufacturer. It is noted that the invention is not limited to manufacturer incentive programs, but instead the invention can be used in order to implement and manage incentive programs or the like that are offered by anyone, such as the store itself or another entity.

Currently, retailers and manufacturers have no satisfactory tool that enables such incentive programs to be easily managed and implemented in a way that assures that only proper spiffs are paid, regardless of whether or not a product is later returned. As explained above, incentive programs are currently difficult to manage and police at the retail and manufacturer level. As a result, significant amounts of time and money are wasted in connection with such incentive programs.

The present invention provides a tool that is implemented in connection with electronic registration (ER) to enable convenient and accurate administration of incentive programs and the like. In accordance with the invention, the ER system is used during the course of an incentive program to assure that only proper spiffs are paid. As an added feature to ER (also known as “ERS”), this invention allows a retailer in cooperation with it's vendors to properly implement and police an incentive program while minimizing the possibility for fraudulent or otherwise improper spiff or commission payments.

The invention is preferably implemented through software which enables the ER system to be used to implement an incentive program. Specifically, the ER system is modified/enhanced to include functionality that enables an incentive program to be defined thereon and in a way that enables qualifying sales that be recognized by the ERS system when they are registered at the point of sale (or at a later time). In other words, the ER system is programmed to recognize the qualifying sales and, for example, the particular employee responsible for the sale. The modified ER system performs the accounting for the incentive program and is capable of providing detailed reports that can be used by the manufacturer (or other entity) to determine and process the spiff payments. Preferably, the product registration database, from which the spiff reports are preferably generated, is located centrally for a plurality of retail outlets carrying products of many different manufacturers. In this way, the central ER system can be used by any of the manufacturers/retailers to implement and manage an incentive program at any of the retail establishments by, for example, contracting with the entity that runs the centralized ER system. The appropriate data for the incentive program is then collected by the ER system for the relevant time period and reporting is provided to the retailer and/or the manufacturer so that the proper spiff payments can be made.

One significant advantage of using the ER system to manage the incentive program is that return transactions can be automatically and accurately accounted for when determining commissions due. In other words, the ER system knows when a product is returned, as well as whether the product was sold under a spiff program and who made the sale. Thus, the spiff credit can be adjusted or canceled, as appropriate, when returns are made. This makes managing of the incentive program much easier as compared to prior techniques. Using the ER system also prevents fraud in that the sales records are maintained very accurately by the ER system and any attempts to improperly register products to obtain improper spiff payments that have not actually be sold can be detected by the system through auditing procedures and the like.

In order to implement the invention, the ER system is provided with functionality (through software and/or hardware) that enables incentive programs to be implemented and tracked with respect to each product that is sold under an incentive program. In other words, all of the information required to conduct an incentive program is entered into the ER system, with very little extra time or effort required over and above the typical ER process. Thus, the ER system enables the incentive program to be tracked on a product by product basis by using a unique identifier (e.g., serial number), in accordance with the ER system.

In accordance with another aspect of the invention, the ER system can be used to provide reports of the incentive program to the manufacturer and/or the retailer. In other words, due to the fact that the incentive program is managed and tracked by the ER system, and the fact that return/refund information is available in the ER system, accurate reports can be generated that provide information (either in detailed or summary form) for any incentive program for review by the retailer and/or the manufacturer. In this way, the success of the incentive program can be more easily determined with less time and effort as compared to conventional incentive programs. Also, in accordance with the invention, the ER system can be used to provide information to the sales personnel regarding spiffs earned to date, as well as any other desired reports.

The instant invention provides a mechanism that can be used in conjunction with ER systems to implement and manage incentive programs, regardless of who is offering the program. In this way such programs can be centrally managed and policed with very little additional effort at the manufacturer and/or retail level. The invention can be easily implemented in known ER systems by modifying the system to accept information on incentive programs so that the system recognizes purchases made under such programs. The invention can accommodate various types of incentive programs and deal with a variety of different situations that can arise during such a program in an efficient and accurate manner. Thus, the invention enables incentive programs to be accurately and efficiently implemented (regardless of who is offering the incentive and how), while still enjoying all of the benefits of electronic product registration.

### BRIEF DESCRIPTION OF THE DRAWINGS

Other objects, features, advantages and characteristics of the present invention will become apparent from the following detailed description of the exemplary embodiments, when read in conjunction with the accompanying drawings, in which:

FIG. 1 is a schematic block diagram illustrating an example of an overall electronic product registration (ER) system that may be used in accordance with the present invention;

FIG. 2 is a high level flow chart of some of the main steps performed in accordance with conventional electronic product registration (ER) systems;

FIG. 3 is a high level flow chart of the main steps performed in accordance with the preferred embodiment of the ER incentive program management system of the instant invention;

FIG. 4 is a high level flow chart of the main steps performed by a manufacturer in accordance with the preferred embodiment of the ER incentive program management system of the instant invention; and

FIG. 5 is a high level flow chart of the main steps performed by a retailer in accordance with the preferred embodiment of the ER incentive program management system of the instant invention.

### DETAILED DESCRIPTION OF PREFERRED EMBODIMENTS

The present invention is described in the context of particular exemplary embodiments. However, it will be recognized by those of ordinary skill that modification, extensions and changes to the disclosed exemplary embodiments may be made without departing from the scope of the instant invention. In short, the following descriptions are provided by way of example only, and the present invention is not limited to the particular preferred embodiments disclosed herein, except as indicated in the pending claims.

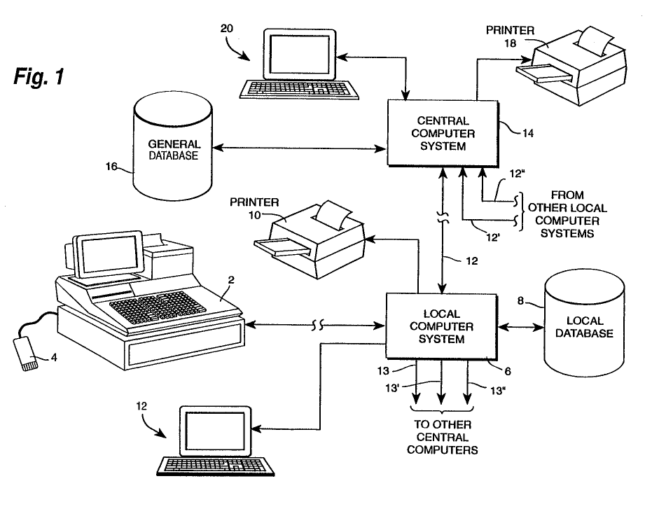

An example of one type of electronic product registration (ER) system that is preferably used in connection with the instant invention is illustrated in FIG. 1. Briefly, this example system includes a point of sale register 2 and an associated bar code scanner 4. The register 2 is preferably connected with a local computer system 6 in any suitable manner. In certain situations (e.g., single store retailers), it may be advantageous to have the local computer system 6 located in proximity to the register 2. For large chain stores, however, it may be advantageous to situate the local retailer computer 6 at a central location with links to the registers 2 at individual stores. The particular arrangement will depend on the preferences and circumstances of the specific retailer and may vary in accordance therewith.

The local retailer computer system includes an associated local database 8 for storing registration information. Additionally, a local printer 10 and an operator terminal 11 may be provided. The operator terminal may be used, for example, by a store clerk upon return of merchandise to locate pertinent sales information in the local database 8. The printer 10 may be used to produce hard copies of, for example, end-of-day sales reports and/or the like.

In the exemplary embodiment, a communication channel 12 is provided between the retailer computer system 6 and a central computer system 14. The central registration computer system may, for example, be an independent registration center computer system which electronically registers product transactions for a number of different retailers. In other words, the central computer system may be operated by a third-party service provider.

A general registration database 16 is associated with the central registration computer system 14 for storing transaction information from a plurality of retailer computer systems 6. Additionally, a printer 18 and an operator terminal 20 may be included with the central registration computer system 14. The central registration computer system may maintain a number of data files pertaining to individual retailers, manufactures and the like. These data files include information applicable to the particular individual retailer, distributor, manufacturer or the like and are preferably maintained by that particular individual or entity. For example, a data file may contain specific return/warranty policy information applicable to that particular individual or entity.

It should be appreciated that the central computer system 14 is preferably intended to handle product registrations for a number of different manufacturers and/or other vendors. Accordingly, the general registration database may employ a structure wherein the product registrations for each participating vendor is maintained in separate areas. Alternatively, separate databases may be employed for each participating vendor. Of course, other data structures may be employed so long as the registration center is able to properly keep track of the product transaction information and particular return and/or warranty policies associated with each transaction.

As illustrated in FIG. 1, the central registration computer system 14 may have a number of additional communications links 12′, 12″, etc. for receiving information from other local computer systems. Thus, for example, a registration center may receive information from a number of different retailers. Additionally, the local computer system 6 may include a number of additional communication channels 13, 13′, 13″, etc. for connecting with other central computer systems. Accordingly, an individual retailer can electronically register products with a number of different registration databases, if desired. Furthermore, a number of communication channels 15, 15′, 15″, etc. can be provided for communications between the central registration computer system 14 and individual manufacturer computer systems and computer systems of third party service providers, law enforcement agencies and/or the like. Of course, a general access channel such as an internet connection may also be made available for authorized access to the central computer system 14.

The electronic registration process begins when a customer brings merchandise to the register 2 for check-out. The sales clerk enters the SKU number which identifies the type of product involved in the transaction (e.g., Super Nintendo Entertainment System, Nintendo Game Boy, Nintendo N64, etc.) by, for example, scanning a UPC product code included on the product packaging. Of course, key entry or another technique for entering the SKU number may be used. Electronic registration might not be necessary for a substantial number of small commodity products (e.g., batteries, candy, diapers, etc.) that are commonly sold by retailers. Accordingly, a check may be made, based on the type of product as identified by the UPC code, to determine whether this is a product for which electronic registration is desired. If so, the store associate is prompted to enter the serial number (or other unique identifier) of the individual item.

The serial number may be entered, for example, by scanning a serial number printed on the packaging. Alternatively, the serial number as it appears on the product may be scanned through a window in the packaging. This alternative ensures that the individual product is identified even if it is mispackaged. Also, repackaging of returned merchandise would be simplified. Other techniques, such as key entry, may also be used. Because the serial number is unique to each individual product, it acts as individual production identification information.

Once the serial number is entered, a check may be made to ensure that the serial number is valid. If not, the store associate is again prompted to enter the serial number. This is repeated until a valid serial number is obtained. Once the serial number is verified, a local database may be updated with the serial number information and any other necessary or desired information. At minimum, however, the local database should include an indication of the date on which the transaction took place. Other information might include the price paid, the store associate responsible for the sale, and the like.

The serial number of the individual product is preferable printed as part of a written customer transaction receipt. The serial number may be printed adjacent the description and SKU number of the registered product. Thus, it will be a simple matter to correlate serial numbers with associated products, particularly when several registered products appear on a single customer sales receipt. Of course, additional information may be printed as well.

The date of the transaction will typically be printed at either the beginning or the end of the sales receipt, but may appear anywhere on the receipt. After the serial number is printed, a check is made to determine whether sales are complete. Ordinarily, this will be based on the store associate hitting a TOTAL button on the cash register. Thereafter, the central registration computer system 14 is contacted and the general registration database 16 is updated with the transaction information.

Inasmuch as ER systems are known, further specific details regarding ER systems themselves will not be provided herein except as needed for a complete understanding of the invention. As seen from the above description of an ER system, there is no functionality in the conventional ER system to implement incentive programs or to manage such programs at the manufacturer or retail level. The ER system does, however, preferably include the policies of both the vendor and the retailer and enables the policies of both parties to be easily and conveniently enforced.

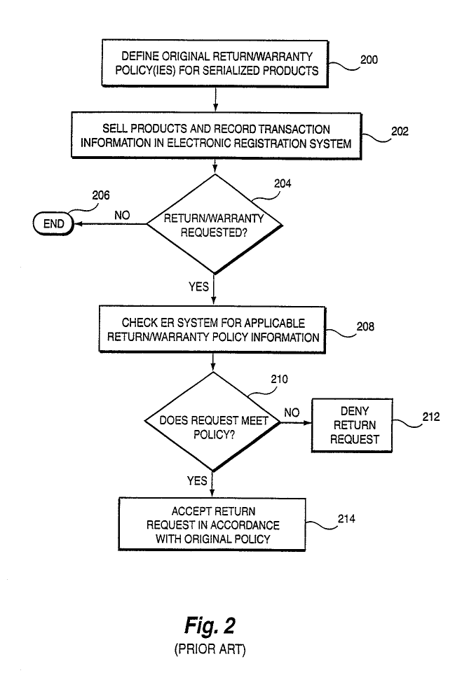

FIG. 2 shows the main steps performed in connection with conventional ER systems. As shown in FIG. 2, the return/warranty policy(ies) are defined for serialized products and are entered into the ER system (step 200). The ER system uses the policies and the sales transaction information, as well as the date on which a return is requested, to determine if the product qualifies for return when presented for return. Thus, when the products are sold, the sales transaction is recorded in the ER database (step 202). If the consumer is satisfied with the product, then the process ends (step 206). On the other hand, if a return is requested (step 204), the ER system is accessed to obtain the return qualification information for the specific product being presented for return (step 208). In accordance with conventional ER systems, the return request is handled based on the return qualification information provided by the ER system based on the original policies under which the product was originally sold. Thus, based on the return qualification information provided by the ER system, a determination is made as to whether or not the product qualifies for return/warranty repair or the like (step 210). If the product does qualify for the action requested, the request can be honored by the retailer and the transaction can be completed (step 214). On the other hand, if the ER system indicates that the product does not qualify for the requested action, the customer is typically denied the return or warranty repair (step 212). Of course, the store clerk could decide, for some reason, to ignore the ER information and accept the product anyway. There is, however, no mechanism in convention ER system for handling incentive programs in addition to the general electronic registration functions provided by such systems.

As explained below, the instant invention provides an improved ER system that enables incentive programs to be easily and efficiently implemented and managed with confidence that they will not be subject to abuse, fraud or other disadvantageous events.

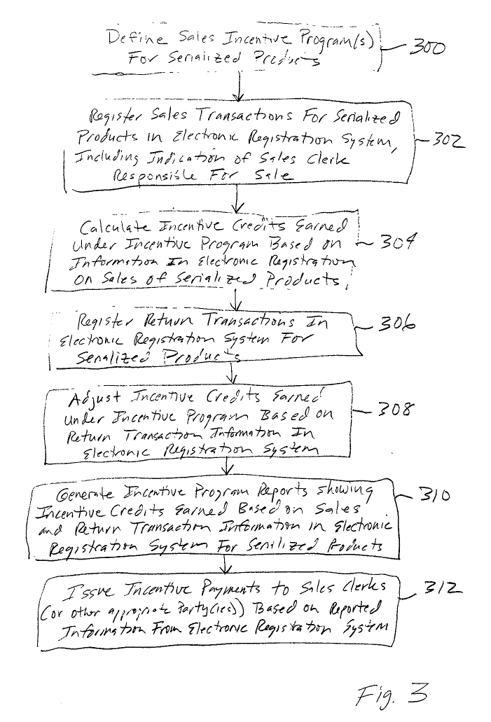

FIG. 3 shows the main steps performed in connection with the preferred embodiment of ER sales incentive management system of the instant invention. As shown in FIG. 3, the process begins when a manufacturer (or other party) defines an incentive program in connection with the sale of certain serialized (or other uniquely identified) products (Step 300). Typically, the incentive program is designed to improve the sales of certain products associated with the program sponsor (e.g., manufacturer). Various policies are defined for the incentive program, such as starting dates and ending dates for the incentive program, as well as the amount of incentive earned for each sale of a qualified product. Any suitable policies or rules can be defined by the sponsoring party in connection with the incentive program. A plurality of different incentive programs can also be defined at any one time.

Once an incentive program has been established, the program information, including the policies and/or rules associated therewith, is recorded in the electronic registration system, so that the system can begin to keep track of all events that relate to the incentive program. Sales transactions are then registered in the electronic registration (ER) system. In addition to the conventional sales transaction information recorded in the ER system, such as serial number, date of sale, etc., the identity of the sales associate (or other party) who is to receive credit for the sale under the incentive program is also entered into the ER system (step 302). The identity information may be an employee number or any other unique identifier for the party to which the credit is to be given for the sale. In this way, the ER system has the information it needs to calculate or accumulate the incentive credits earned for each party participating in the program and for all incentive programs currently being implemented through the ER system (step 304). The ER system may, for example, maintain a database of earned credit information by program and by individual party (e.g., sales associate) who are earning credits under one or more of the active incentive programs.

In addition to registering sale transactions in the ER system, return transactions are also qualified and registered in the ER system (step 306). Qualifying and registering returns of purchased products is preferable done in the conventional manner, i.e., the applicable return policies are checked in the ER system for the particular product being presented for return, and, if the return is acceptable, the serial number of the returned product and the return date are entered into the ER system. In this way, the ER system knows what serialized products have been returned and the date of return.

The ER system can then adjust the credits earned information in its database to reflect the fact that a product purchased under an incentive program has been returned (step 308). Depending on the particular policies or rules of the applicable incentive program, the adjustment could be a debit that is equal to the credit that was originally given for the sale, or it could be a lesser debit so that some credit is still given to the store associate for making the sale even though it was ultimately returned. In other words, the adjustment may take any form as defined by the incentive program itself. The program may, for example, have a cut-off date where the sales associate gets credit for the sale as long as the product is not returned before the cutoff date. All such policies and rules are implemented and managed by the ER system based on the sales and return transaction information contained in its database(s).

The ER system of the invention then generates periodic reports that show the status of each active incentive program, including information of the sales, returns and credits earned for each program (step 310). This reported information is then used by the manufacturer (or other program sponsor) to pay the party(ies) that have earned credits under each program, and by the retailer to distribute the payments appropriately (step 312). In this way, the incentive program is implemented and managed in an accurate and convenient manner with very little extra effort over and above the steps used in conventional electronic registration systems.

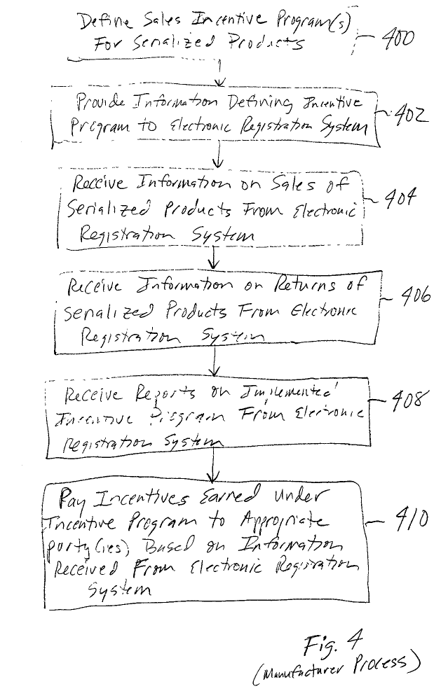

FIG. 4 shows the main steps performed by a manufacturer (or other sponsoring party) in connection with the ER sales incentive program management system of the instant invention. As indicated above, the first step involves the manufacturer defining an incentive program that it believes would be beneficial to sales of its products (step 400). Once the incentive program(s) is defined, the manufacturer communicates the details of the program to the ER system (or the third party service provider that operates the ER system), so that the program can be set-up and initialized in the ER system (step 402). This process typically involves defining the products that have an incentive associated therewith, the start date and end date for the program, the amount of the credit that is to be given for sales, and any rules or policies with respect to, for example, returns of products for which an incentive credit has been earned, and/or any other desired rules and/or policies for the program.

Once the program is initialized in the ER system and the retailer begins to sell products under the incentive program, the ER system can be accessed by the manufacturer in order to receive information on sales of serialized products under the program (step 404). In this way, the manufacturer can monitor the incentive program in an easy and accurate manner through the ER system. When the retailer accepts returns of serialized products that were sold under the incentive program, those returns are also recorded in the ER system. The ER system recognizes the fact that the return is a product for which an incentive program is active and adjusts the credits appropriately based on the policies and/or rules for the program. The manufacturer is then able to access the ER system to also obtain information on the returns of products originally sold under the incentive program (step 406). Preferably, the ER system is operable to generate reports on the active (and/or inactive) incentive programs that detail the sales and return activity for products that are part of an incentive program, as well as the credits earned to date based on both sales and return information in the ER system (step 408). The manufacturer can then use the reports from the ER system to pay the appropriate party(ies) any incentive credits earned based on information provided by the ER system. The payments may also be entered into the ER system so that they can be accounted for in the ER system. In other words, the ER system can keep track of the payments owed and received under the incentive program, so that at any point in time the ER system can provide accurate accounting information for each incentive program implemented therethrough. In this way, the manufacturer can easily implement a successful incentive program through the ER system.

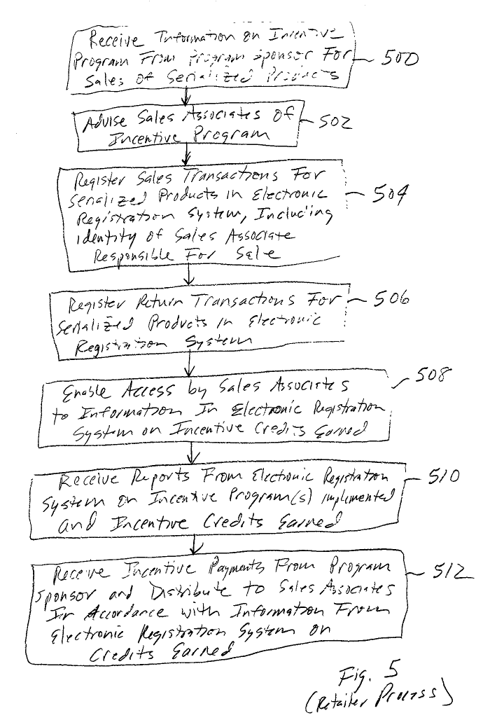

FIG. 5 shows a high level flow chart of the main steps performed by a retailer in accordance with the ER incentive program management system of the instant invention. As shown in FIG. 5, the process starts for the retailer when it receives information from the manufacturer or the ER system itself that an incentive program has been defined for products that it sells (step 500). The retailer then advises its sales associates of the program and the policies and/or rules associated therewith (step 502). The retailer then registers sales of serialized products in the ER system in the conventional manner, except that the retailer also enters information which identifies the sales associate that is responsible for the sale (step 506). The retailer also qualifies any return requests using the ER system and enters any return transactions in the ER system (step 508). The ER system is preferably programmed to enable the retailer and/or the sales associates to access information on the incentive program so that accurate and current information on credits earned under the program can be obtained at any time (step 508). The retailer then receives periodic reports from the ER system on the incentive programs which show the incentive credits earned (step 510). Finally, the retailer receives payment from the manufacturer (or other program sponsor) for the credits earned as indicated in the ER system reports. The retailer can then distribute the payments to the appropriate parties based on the information in the ER system reports (step 512). In this way, the retailer can easily participate in an incentive program with little extra effort over and above the conventional ER process.

As can be seen from the above description of the invention, the instant invention provides a mechanism that can be used in conjunction with ER systems to implement and manage incentive programs, regardless of who is offering the program. In this way such programs can be centrally managed and policed with very little additional effort at the manufacturer and/or retail level. The invention can be easily implemented in known ER systems by modifying the system to accept information on incentive programs so that the system recognizes purchases made under such programs. The invention can accommodate various types of incentive programs and deal with a variety of different situations that can arise during such a program in an efficient and accurate manner. Thus, the invention enables incentive programs to be accurately and efficiently implemented (regardless of who is offering the incentive and how), while still enjoying all of the benefits of electronic product registration.

What is claimed is:

1. A method of implementing a sales incentive program for sales of certain products having a unique identifier associated therewith, said method comprising:
defining a sales incentive program in an electronic product registration system, wherein the sales incentive program provides incentive payments to parties responsible for sales of the products;
registering sales of the products in the electronic product registration system, wherein registering sales includes recording, for each transaction, transaction information including a unique identifier for the product being purchased, a date associated with the sale, and an identifier of the specific party responsible for the sale;
registering returns of products in the electronic product registration system, including indicating a unique identifier for each product returned; and
performing accounting functions in the electronic product registration system to determine credits earned under the incentive program based on registered sale and return information in the electronic product registration system.

2. The method of claim 1, further including generating reports on the credits earned for use by a sponsor of the incentive program.

3. The method of claim 1, wherein defining a sales incentive program includes identifying in the electronic product registration system products for the incentive program, starting and ending dates for the incentive program, and at least one policy to be used by the electronic product registration system when performing the accounting functions.

4. The method of claim 3, wherein defining at least one policy includes defining an amount of a credit that will be earned for a sale of a product under the incentive program.

5. The method of claim 4, wherein defining at least one policy further includes defining an amount of a debit that will be applied for a return of a product originally purchased under the incentive program.

6. The method of claim 1, wherein the unique identifier is a serial number.

7. The method of claim 1, wherein registering sales includes registering sales in the electronic product registration system from a plurality of different locations.

8. The method of claim 1, further including generating reports from the information on sales and returns in the electronic product registration system indicating credits earned under the incentive program for each party for which an identifier has been entered in connection with a sales transaction.

9. The method of claim 1, further including enabling access to the electronic registration system by the parties responsible for sales for the purpose of informing the parties of credits earned to date under the incentive program.

10. A method of implementing a sales incentive program for sales of certain products having a unique identifier associated therewith, said method comprising:
defining a sales incentive program in an electronic product registration system, wherein the sales incentive program provides incentive payments to parties responsible for sales of the products;
registering sales of the products in the electronic product registration system, wherein registering sales includes recording, for each transaction, transaction information including a unique identifier for the product being purchased, a date associated with the sale, and an identifier of the specific party responsible for the sale;
applying a credit in the electronic registration system to the specific party responsible for each sale;
registering returns of products in the electronic product registration system, including indicating a unique identifier for each product returned;
applying a debit in the electronic product registration system for each return of a product that was previously sold under the incentive program, wherein the debit is applied to the specific party that was responsible for the sale; and
performing reporting functions in the electronic product registration system to determine credits earned under the incentive program based on registered sale and return information in the electronic product registration system.

11. The method of claim 10, further including generating reports on the credits earned for use by a sponsor of the incentive program.

12. The method of claim 10, wherein defining a sales incentive program includes identifying in the electronic product registration system products for the incentive program, starting and ending dates for the incentive program, and at least one policy to be used by the electronic product registration system when performing the accounting functions.

13. The method of claim 12, wherein defining at least one policy includes defining an amount of a credit that will be earned for a sale of a product under the incentive program.

14. The method of claim 13, wherein defining at least one policy further includes defining an amount of a debit that will be applied for a return of a product originally purchased under the incentive program.

15. The method of claim 10, wherein the unique identifier is a serial number.

16. The method of claim 10, wherein registering sales includes registering sales in the electronic product registration system from a plurality of different locations.

17. The method of claim 10, further including generating reports from the information on sales and returns in the electronic product registration system indicating credits earned under the incentive program for each party for which an identifier has been entered in connection with a sales transaction.

18. The method of claim 10, further including enabling access to the electronic registration system by the parties responsible for sales for the purpose of informing the parties of credits earned to date under the incentive program.
